(19) United States
(12) Patent Application Publication
(10) Pub. No.: US 2026/0119601 A1
(43) Pub. Date: Apr. 30, 2026

(54) Method for Solving System of Linear Equations and Related Device

(71) Applicant: Huawei Cloud Computing Technologies Co., Ltd., Guizhou (CN)

(72) Inventors: Jinhao Guo, Shenzhen (CN); Fan Xiao, Shenzhen (CN); Wengang Yan, Shenzhen (CN); Xiaofei Wu, Shenzhen (CN); Yusi Ye, Shenzhen (CN)

(73) Assignee: Huawei Cloud Computing Technologies Co., Ltd., Guizhou (CN)

(21) Appl. No.: 19/431,494

(22) Filed: Dec. 23, 2025

Related U.S. Application Data
(63) Continuation of application No. PCT/CN2024/079225, filed on Feb. 29, 2024.

(30) Foreign Application Priority Data
Jun. 25, 2023 (CN) 202310752934.X
Sep. 26, 2023 (CN) 202311253313.3

(51) Int. Cl. G06F 17/12

(52) U.S. Cl. CPC G06F 17/12

(57) ABSTRACT

In a method for solving a system of linear equations, a computing device or a computing device cluster may obtain description information input by a user, where the description information includes information about a system of linear equations; perform inference on the description information using an artificial intelligence (AI) model to obtain a first initial solution corresponding to the system of linear equations; determine a target initial solution based on the first initial solution; and iteratively solve the system of linear equations based on the target initial solution. In the method, the AI model can identify features of the system of linear equations based on the input description information.

### CROSS-REFERENCE TO RELATED APPLICATIONS

This is a continuation of International Patent Application No. PCT/CN2024/079225 filed on Feb. 29, 2024, which claims priority to Chinese Patent Application No. 202311253313.3 filed on Sep. 26, 2023 and Chinese Patent Application No. 202310752934.X filed on Jun. 25, 2023, all of which are hereby incorporated by reference.

### TECHNICAL FIELD

This disclosure relates to the field of artificial intelligence (AI) technologies, and, to a method for solving a system of linear equations and a related device.

### BACKGROUND

In fields such as industrial simulation, computer-aided engineering (CAE) simulation in engineering design is often used to analyze physical performance of engineering and products.

When the CAE simulation is used to solve a specific physical problem, solving a system of linear equations is usually an important and time-consuming task.

A frequently-used method for solving a system of linear equations is a linear iteration method. The linear iteration method is to obtain an approximate solution of the system of linear equations through a finite quantity of iterations.

When the system of linear equations is solved using the linear iteration method, impact of an initial solution on an iterative solving process is significant. If the initial solution is far from a real solution, more iterations need to be performed to obtain the real solution through convergence. Consequently, calculation time is prolonged. In addition, if the initial solution is inappropriate, the iteration may further fail to converge.

The initial solution suitable for the current to-be-solved system of linear equations is usually determined based on expert experience, or a default initial solution is used.

However, because a scale and a property of the system of linear equations change greatly, it is usually difficult for the default initial solution to produce a good effect in a solving process of the system of linear equations. However, the expert experience usually needs to be accumulated for a long period of time, and participation of related experts is needed in the solving process, affecting processing efficiency. Therefore, a method that can be used for efficiently generating an appropriate initial solution of the to-be-solved system of linear equations is urgently needed, to better calculate a solving result of the system of linear equations.

### SUMMARY

Embodiments of this disclosure provide a method for solving a system of linear equations, to conveniently and efficiently generate an appropriate initial solution of a to-be-solved system of linear equations. This disclosure further provides a corresponding apparatus, a computing device, a computing device cluster, a computer-readable storage medium, a computer program product, and the like.

A first aspect of this disclosure provides a method for solving a system of linear equations, applied to a computing device or a computing device cluster. In the method, description information input by a user may be obtained, where the description information includes information about a system of linear equations, and the information about the system of linear equations includes a right-hand side. Inference is performed on the description information using an AI model, to obtain a first initial solution corresponding to the system of linear equations. A target initial solution is determined based on the first initial solution, and the system of linear equations is iteratively solved based on the target initial solution, to output a solving result of the system of linear equations.

In the first aspect, the AI model can identify features of the system of linear equations based on the input description information, to efficiently determine the appropriate first initial solution of the system of linear equations, to determine the target initial solution based on the first initial solution, and efficiently and accurately iteratively solve the system of linear equations based on the target initial solution, thereby improving solving efficiency of the system of linear equations, and avoiding a generalization problem caused by an initial solution determined based on expert experience and a default initial solution.

In a possible implementation of the first aspect, the description information further includes to-be-solved physical problem information, the system of linear equations is obtained by performing numerical simulation on the to-be-solved physical problem information, and the to-be-solved physical problem information includes at least one of the following: a boundary condition, mesh information, and a physical equation.

Algorithms for determining the initial solution of the system of linear equations are usually used to predict the initial solution of the system of linear equations in a mathematical derivation manner, and are, for example, a proper orthogonal decomposition (POD) algorithm and a Fischer algorithm.

Only information such as a coefficient matrix in the system of linear equations is usually considered for these algorithms for determining the initial solution of the system of linear equations, but features of a to-be-solved problem cannot be well reflected based only on the coefficient matrix in the system of linear equations. Therefore, there is usually a large deviation in an effect of the initial solution predicted using these algorithms for determining the initial solution of the system of linear equations, and appropriate initial solutions cannot be provided for various scenarios.

In this possible implementation, considering that the system of linear equations is constructed based on the physical problem information. In other words, the physical problem information affects a subsequently generated system of linear equations, and the physical problem information used as upper-layer scenario information of the subsequently generated system of linear equations affects parameters such as the coefficient matrix and/or the right-hand side in the subsequently generated system of linear equations.

It can be learned that, the physical problem information is closely related to the constructed system of linear equations when being used as the upper-layer scenario information used to construct the system of linear equations. Therefore, in this possible implementation, the description information may include the information about the system of linear equations and the physical problem information associated with the system of linear equations. Then, the AI model may be used to fully mine a plurality of aspects of information such as the information about the system of linear equations and the physical problem information associated with the system of linear equations, to determine the first initial solution that meets the features of the current physical problem and that is suitable for the current to-be-solved system of linear equations. It can be learned that, using the method, appropriate initial solutions can be efficiently provided for systems of linear equations corresponding to various physical problems in different scenarios, thereby improving solving efficiency of the corresponding systems of linear equations.

In a possible implementation of the first aspect, determining the target initial solution based on the first initial solution, and iteratively solving the system of linear equations based on the target initial solution, to output the solving result of the system of linear equations include obtaining first configuration information, where the first configuration information carries at least one initial solution generation manner used to generate an initial solution, obtain a plurality of initial solutions in the at least one initial solution generation manner indicated by the first configuration information, where the plurality of initial solutions includes the first initial solution, selecting the target initial solution from the plurality of initial solutions, and iteratively solving the system of linear equations based on the target initial solution, to output the solving result of the system of linear equations.

In this possible implementation, considering that different initial solution generation manners may be suitable for physical problems in different physical scenarios, the plurality of initial solutions may be provided based on the first configuration information. In this way, adaptation degrees of different initial solution generation manners in different physical problems may be fully considered, and a more appropriate target initial solution in the physical problem of a current category is selected from the plurality of initial solutions, such that quality of the finally obtained target initial solution is improved, thereby improving solving efficiency of an iterative solving process of the system of linear equations.

In a possible implementation of the first aspect, selecting the target initial solution from the plurality of initial solutions includes obtaining second configuration information, where the second configuration information carries at least one heuristic policy, and selecting the target initial solution from the plurality of initial solutions according to the at least one heuristic policy.

In this possible implementation, the plurality of initial solutions is screened according to the at least one heuristic policy, such that the initial solution that better meets the features of the current physical problem can be selected from the plurality of initial solutions as the target initial solution, such that quality of the finally obtained target initial solution is improved.

In a possible implementation of the first aspect, selecting the target initial solution from the plurality of initial solutions includes obtaining third configuration information, where the third configuration information carries an evaluation policy, the evaluation policy includes an evaluation indicator, or includes an evaluation indicator and a weight corresponding to each evaluation indicator, and the evaluation indicator includes one or more of solving duration, solving precision, and a quantity of iterations, and selecting the target initial solution from the plurality of initial solutions according to the evaluation policy.

In this possible implementation, any evaluation indicator may be used to evaluate iteration performance when the corresponding initial solution is used as the initial solution in the iterative solving process of the system of linear equations. In this way, the corresponding target initial solution with good iteration performance may be selected from the plurality of initial solutions based on the information such as the evaluation indicator and the related weight in the evaluation policy.

In a possible implementation of the first aspect, the method further includes generating training data, where the training data includes a training sample and a label corresponding to the training sample, the training sample includes the description information, and the label corresponding to the training sample is obtained based on the first initial solution, and training the AI model based on the training data, to obtain an optimized AI model.

In this possible implementation, the AI model may be continuously iteratively updated with a change of user data distribution and a scale in an actual application scenario for continuous optimization, such that the optimized AI model better adapts to a requirement of the current scenario, and can generate better initial solutions for different physical problems and corresponding systems of linear equations, thereby improving solving efficiency.

In a possible implementation of the first aspect, the method further includes obtaining a performance indicator corresponding to the solving result, where the performance indicator includes one or more of solving duration, solving precision, and a quantity of iterations, and training the AI model based on the training data, to obtain the optimized AI model includes training the AI model based on the training data and a loss function, to obtain the optimized AI model, where the loss function is constructed based on the performance indicator.

In a possible implementation of the first aspect, the AI model is a general model or a model used to solve a partial differential equation (PDE). The general model includes a convolutional neural network (CNN) or a physics-informed neural network (PINN), and the model used to solve the PDE includes deep operator network (DeepONet).

In this possible implementation, the loss function may reflect a performance indicator in a label of a corresponding sample. The performance indicator in the label of the corresponding training sample means that corresponding poorer solving performance (for example, longer solving duration, lower solving precision, and a larger quantity of iterations) indicates a corresponding larger loss value. In addition, in some examples, the loss function may be further used to evaluate a difference between a training initial solution output by a to-be-trained model in an iteration process and an initial solution in a label of a corresponding sample.

A second aspect of this disclosure provides a data processing apparatus. The apparatus has a function of implementing the method according to any one of the first aspect or the possible implementations of the first aspect. The function may be implemented using hardware, or may be implemented by executing corresponding software by hardware. The hardware or software includes one or more modules corresponding to the foregoing function, for example, an obtaining module and a processing module.

A third aspect of this disclosure provides an electronic device. The electronic device includes at least one processor, a storage, and computer-executable instructions that are stored in the storage and that can be run on the processor. When the computer-executable instructions are executed by the processor, the processor performs the method according to any one of the first aspect or the possible implementations of the first aspect.

A fourth aspect of this disclosure provides a computer-readable storage medium storing one or more computer-executable instructions. When the computer-executable instructions are executed by a processor, the processor performs the method according to any one of the first aspect or the possible implementations of the first aspect.

A fifth aspect of this disclosure provides a computer program product storing one or more computer-executable instructions. When the computer-executable instructions are executed by a processor, the processor performs the method according to any one of the first aspect or the possible implementations of the first aspect.

A sixth aspect of this disclosure provides a chip system. The chip system includes a processor configured to support an electronic device in implementing a function in any one of the first aspect or the possible implementations of the first aspect. In a possible design, the chip system may further include a storage. The storage is configured to store necessary program instructions and data for the electronic device. The chip system may include a chip, or may include a chip and another discrete device.

For technical effects achieved by any one of the second aspect to the sixth aspect or the possible implementations of the second aspect to the sixth aspect, refer to the technical effects achieved by the first aspect or the related possible implementations of the first aspect. Details are not described herein again.

### BRIEF DESCRIPTION OF DRAWINGS

FIG. 1 is a schematic flowchart of an example of CAE simulation according to an embodiment of this disclosure;

FIG. 2 is an example diagram of a data center according to an embodiment of this disclosure;

FIG. 3 is an example diagram of executing a CAE simulation-related task via a cloud management platform according to an embodiment of this disclosure;

FIG. 4 is a diagram of an embodiment of a method for solving a system of linear equations according to an embodiment of this disclosure;

FIG. 5 is an example diagram of iteratively solving a system of linear equations by an initial solution adaptive optimization module according to an embodiment of this disclosure;

FIG. 6 is an example diagram of iteratively solving a system of linear equations according to an embodiment of this disclosure;

FIG. 7 is an example diagram of executing a system of linear equations solving task via a cloud management platform according to an embodiment of this disclosure;

FIG. 8 is an example diagram of a computer model of a solenoid valve according to an embodiment of this disclosure;

FIG. 9 is a diagram of an embodiment of an apparatus for solving a system of linear equations according to an embodiment of this disclosure;

FIG. 10 is a diagram of a structure of a computing device according to an embodiment of this disclosure;

FIG. 11 is a diagram of a structure of a computing device cluster according to an embodiment of this disclosure; and

FIG. 12 is a diagram of a structure of a computing device cluster according to an embodiment of this disclosure.

### DESCRIPTION OF EMBODIMENTS

The following describes embodiments of this disclosure with reference to the accompanying drawings in embodiments of this disclosure. Terms used in implementations of this disclosure are merely used to explain specific embodiments of this disclosure, but are not intended to limit this disclosure.

A person of ordinary skill in the art may learn that, with development of technologies and emergence of a new scenario, technical solutions provided in embodiments of this disclosure are also applicable to a similar technical problem.

In this disclosure, “at least one” means one or more, and “a plurality of” means two or more. “And/or” describes an association relationship between associated objects, and indicates that three relationships may exist. For example, A and/or B may indicate the following three cases: A exists alone, both A and B exist, and B exists alone, where A and B may be singular or plural. The character “/” usually indicates an “or” relationship between the associated objects. “At least one of the following items” or a similar expression thereof means any combination of these items, including any combination of singular items or plural items. In the specification, claims, and accompanying drawings of this disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner that is used when objects having a same attribute are described in embodiments of this disclosure. In addition, the terms “include”, “have” and any other variants thereof are intended to cover non-exclusive inclusion, such that a process, method, system, product, or device that includes a series of units is not necessarily limited to those units, but may include other units not expressly listed or inherent to such a process, method, system, product, or device.

CAE simulation refers to a process of analyzing and solving engineering problems through numerical calculation and simulation using computer-aided engineering technologies. The CAE simulation is an engineering analysis method based on computer technologies, where virtual tests may be performed on a product in a design phase, to evaluate performance, reliability, security, and the like of the product, such that costs and time of actual tests are reduced. The CAE simulation may be applied to various engineering fields, such as machinery, electronics, aerospace, automobiles, and architecture, where various physical phenomena such as structural mechanics, fluid mechanics, and heat conduction can be simulated.

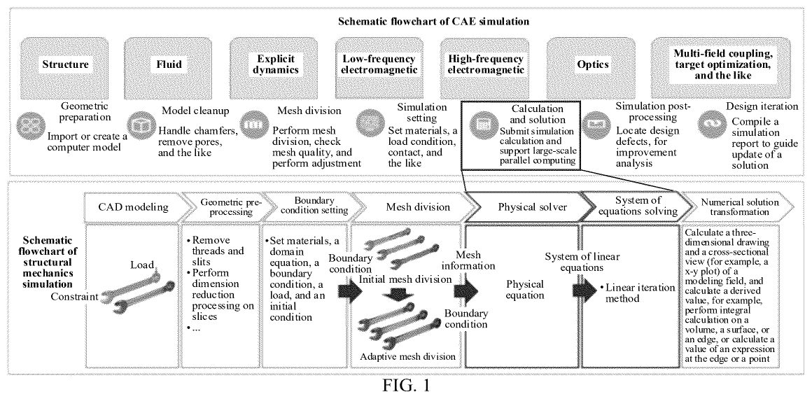

FIG. 1 is a schematic flowchart of an example of CAE simulation.

In a simulation procedure shown in FIG. 1, computer-aided design (CAD) modeling may be first performed on a physical problem, to obtain a computer model. The computer model may be a digital model obtained in a computer using specified software, and may virtually describe a physical structure. The computer model may be newly created through CAD, or may be obtained in another manner (for example, from another device) and imported.

Next, geometric pre-processing may be performed on the computer model obtained through modeling. For example, threads and slits in the computer model may be removed, and dimension reduction processing may be performed on slices. Then, one or more of materials, a domain equation, a boundary condition, a load, an initial condition, and the like of the computer model may be set, and mesh division may be then performed on the computer model. After the mesh division is completed, a physical equation may be generated based on the to-be-resolved physical problem, and a system of PDEs is obtained through construction, and is further discretized into a system of sparse linear equations.

After the system of linear equations is obtained, the system of linear equations needs to be solved. After a solving result is obtained, the corresponding physical problem may be resolved based on the solving result, to obtain a simulation result. For example, in the example shown in FIG. 1, after the solving result of the system of linear equations is obtained, based on the solving result, a three-dimensional drawing or a cross-sectional view of the computer model may be calculated, and a derived value may be calculated, for example, integral calculation is performed on a volume, a surface, or an edge, or a value of an expression at the edge or a point is calculated.

After the simulation result is obtained, simulation post-processing may be performed. For example, defects of a design solution in engineering may be located based on the simulation result, for improvement analysis. In addition, the design solution may be updated and iterated. For example, a simulation report may be written based on the simulation result, to guide update of the corresponding design solution.

The CAE simulation may be used to solve a plurality of physical problems, for example, problems in terms of structure, fluid, explicit dynamics, low-frequency electromagnetic, optics, multi-field coupling, and target optimization shown in FIG. 1. It can be learned that the CAE simulation is widely applied to various actual engineering application scenarios in the industrial field.

In a CAE simulation process, solving the system of linear equations is usually an important and time-consuming task. A frequently-used method for solving a system of linear equations is a linear iteration method. The linear iteration method is to obtain an approximate solution of the system of linear equations through a finite quantity of iterations.

When the system of linear equations is solved using the linear iteration method, an initial solution suitable for the current to-be-solved system of linear equations is usually determined based on expert experience, or a default initial solution is used.

However, because a scale and a property of the system of linear equations change greatly, it is usually difficult for the default initial solution to produce a good effect in a solving process of the system of linear equations. However, the expert experience usually needs to be accumulated for a long period of time, and participation of related experts is needed in the solving process. This affects processing efficiency. Therefore, a method that can be used for efficiently generating an appropriate initial solution of the to-be-solved system of linear equations is urgently needed, to better calculate a solving result of the system of linear equations.

Therefore, embodiments of this disclosure provide a method for solving a system of linear equations, to conveniently and efficiently generate an appropriate initial solution of a to-be-solved system of linear equations.

The method in embodiments of this disclosure may be applied to a computing device cluster, and the computing device cluster may include one or more computing devices.

A type of any computing device is not limited herein. For example, any computing device may be a terminal device, or may be a server, a container, a virtual machine, or the like.

In an example, the computing device cluster may be configured to implement a cloud management platform. In other words, embodiments of this disclosure may be applied to a cloud management platform.

The cloud management platform is configured to manage an infrastructure that provides cloud services, and may provide computing, network, and storage capabilities based on services of a hardware resource and a software resource. For example, the cloud management platform may include one or more data centers, to provide cloud resources via the one or more data centers.

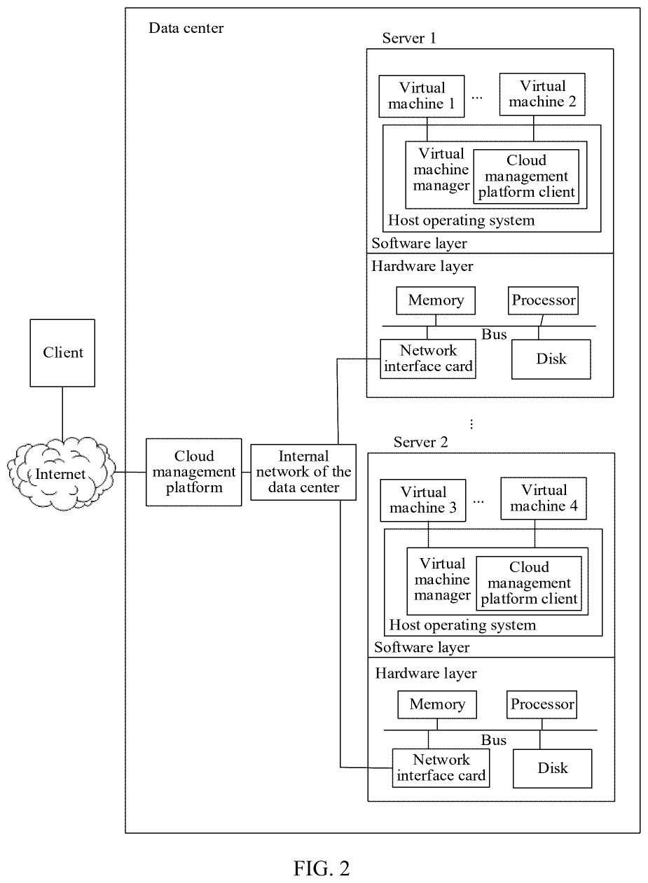

The following describes a data center with reference to a diagram of an architecture shown in FIG. 2.

In FIG. 2, in the data center, the cloud management platform performs information exchange with one server or a plurality of servers (for example, a server 1 and a server 2 in FIG. 2) through an internal network of the data center. The server includes a hardware layer and a software layer. The hardware layer includes hardware configured for the server. A PCI device may be, for example, a device such as a network adapter, a graphics processing unit (GPU), or an offload card that can be inserted into a Peripheral Component Interconnect (PCI) of the server or a PCI Express (PCIe) slot. The software layer includes an operating system installed and running on the server (where an operating system relative to a virtual machine may be referred to as a host operating system). A virtual machine manager (or a hypervisor) is disposed in the host operating system. A function of the virtual machine manager is to implement computing virtualization, network virtualization, and storage virtualization of the virtual machine, and manage the virtual machine. The virtual machine is a complete computer system simulated using software, has functions of a complete hardware system, and runs in an isolated environment. In the system architecture shown in FIG. 2, the plurality of servers is disposed in one cloud data center, the servers may be configured to run virtual machines, and specifications of the virtual machines may be the same or may be different. The virtual machine may also be referred to as an elastic cloud server (ECS), an elastic instance, or the like, and different cloud service providers may have different names.

In an example of this embodiment of this disclosure, the cloud management platform may be a public cloud platform. In this case, a cloud service provider such as an individual or a software developer that has a cloud resource development capability may provide a cloud service for a user, and the user obtains the cloud service through an Internet, but does not have cloud computing resources. In another embodiment of this disclosure, the cloud management platform may be a private cloud platform or a hybrid cloud platform. This is not limited in this disclosure.

In the example shown in FIG. 2, the cloud management platform may provide an access interface (for example, an interface or an application programming interface (API)), and the user of the cloud management platform and the cloud service provider can operate a client to remotely access the access interface to register a cloud account and a password with the cloud management platform, and log in to the cloud management platform after authentication performed by the cloud management platform on the cloud account and the password succeeds, to create, manage, log in to, and operate the virtual machine in the cloud data center.

For example, when a system of linear equations solving task needs to be executed, some enterprises, organizations, or individuals may purchase the cloud service, to execute the related system of linear equations solving task using cloud resources of the cloud management platform, and obtain a corresponding solving result from the cloud management platform.

Certainly, the cloud management platform may alternatively be another type of cloud management platform. This is not limited in embodiments of this disclosure.

In this embodiment of this disclosure, the cloud management platform may provide the user with an initial solution generation service for linear iteration and a linear iterative solver service, and may further provide a numerical calculation solver service, a CAE simulation service, and the like. In this way, the user may execute a CAE simulation-related task via the cloud management platform, for example, may execute the system of linear equations solving task via the cloud management platform.

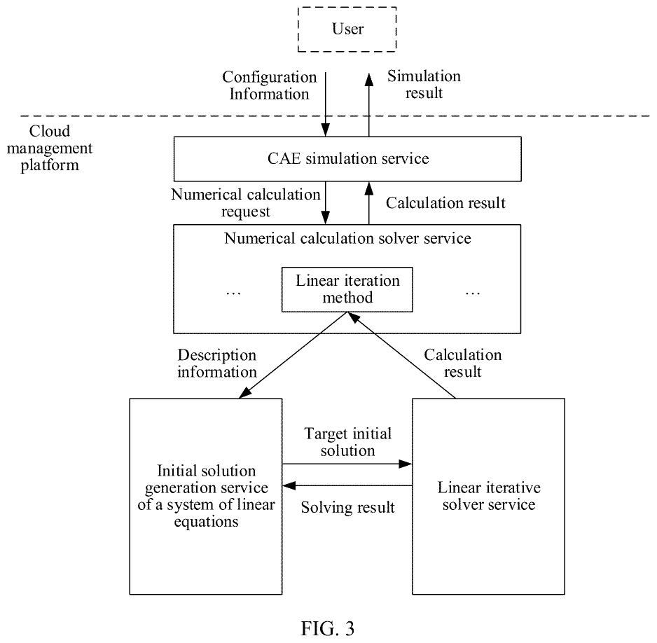

FIG. 3 is an example diagram of executing a CAE simulation-related task via a cloud management platform.

The user may send configuration information to a CAE simulation service of the cloud management platform, to configure the invoked service, and may trigger the CAE simulation service to send a numerical calculation request to a numerical calculation solver service. The numerical calculation request is for requesting to perform numerical calculation related to a system of linear equations. Then, the numerical calculation solver service may select, based on the configuration information of the user and the like, a linear iteration method to solve the system of linear equations, to invoke an initial solution generation service of the system of linear equations, and obtain a target initial solution based on related description information of the system of linear equations, and the initial solution generation service transmits the target initial solution to the linear iterative solver service. The linear iterative solver service may iteratively solve the system of linear equations based on the target initial solution, to obtain a solving result. The solving result may be fed back to the CAE simulation service, such that the CAE simulation service can obtain a simulation result and output the simulation result to the user.

It should be noted that the service in FIG. 3 is merely an example of a service provided by the cloud management platform, and is not a limitation. For example, in some other examples, the cloud management platform does not provide the CAE simulation service. The user performs CAE simulation via the client, to obtain information such as a corresponding computer model. Then, the user may directly send a numerical calculation request to the numerical calculation solver service of the cloud management platform via the client, to request numerical calculation related to a system of linear equations. In another embodiment provided in this disclosure, the service may be deployed as a whole in an offline data center. This is not limited in this disclosure.

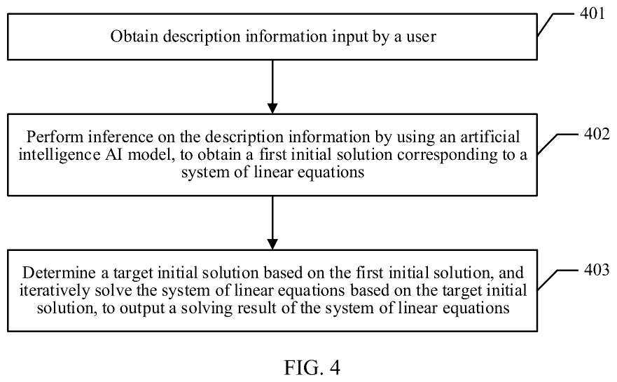

Based on the foregoing computing device cluster and the architecture of the cloud management platform shown in FIG. 3, as shown in FIG. 4, in this embodiment of this disclosure, the computing device cluster that implements the cloud management platform may be configured to perform a method for solving a system of linear equations.

The method for solving a system of linear equations may include steps 401 to 403.

Step 401: Obtain description information input by a user.

The description information includes information about a system of linear equations, and the information about the system of linear equations includes a right-hand side.

In this embodiment of this disclosure, the user may input the description information in a plurality of manners.

In an example, the user logs in to the cloud management platform via a client, and sends the description information to the cloud management platform via the client.

In this example, the user may obtain a computer model for CAE simulation and the like via the client, obtain physical problem information via the computer model, and generate the to-be-solved system of linear equations based on the physical problem information. Then, via the client, the description information including the information about the system of linear equations and the related physical problem information may be sent to the computing device cluster that implements the cloud management platform.

In another example, the user may obtain the description information using cloud resources of the cloud management platform.

In this example, the user not only executes a system of linear equations solving task using the cloud resources of the cloud management platform, but also constructs a computer model for CAE simulation using a first cloud resource of the cloud management platform, obtains corresponding physical problem information using a second cloud resource of the cloud management platform, and constructs the system of linear equations based on the physical problem information. Then, based on an instruction input by the user, the description information including information about the system of linear equations and the related physical problem information is transmitted from the first cloud resource to the second cloud resource that performs the method for solving a system of linear equations in this embodiment of this disclosure.

The information about the system of linear equations is used to describe the system of linear equations. The information about the system of linear equations may include the right-hand side in the system of linear equations. In addition, in some examples, the information about the system of linear equations may further include a coefficient matrix in the system of linear equations.

For example, in a specific system of linear equations Ax=b, a coefficient matrix is A, and a right-hand side is b. In some scenarios, the system of linear equations may be transformed. Information about the system of linear equations may include the right-hand side in the system of linear equations, may include the coefficient matrix, or may include information obtained by transforming the coefficient matrix in the system of linear equations and/or information obtained by transforming the right-hand side.

In addition, in some embodiments, the description information further includes the to-be-solved physical problem information, the system of linear equations is obtained by performing numerical simulation on the to-be-solved physical problem information, and the to-be-solved physical problem information includes at least one of the following: a boundary condition, mesh information, and a physical equation.

The physical problem information is used to describe a to-be-solved physical problem in an industrial application scenario.

A specific field of the industrial application scenario is not limited herein. For example, the industrial application scenario may be a scenario in an engineering field such as machinery, electronics, aerospace, automobiles, or architecture.

In some examples, the physical problem information may be described using a corresponding CAE simulation scenario. For example, in the procedure shown in FIG. 1, in the CAE simulation scenario, one or more of information such as a boundary condition, mesh information, and a corresponding physical equation that are of a corresponding computer model may be obtained through steps such as geometric pre-processing, boundary condition setting, mesh division, and physical equation setting, to obtain physical problem information associated with the system of linear equations.

The physical problem information includes at least one of the following information: a boundary condition, mesh information, and a physical equation.

The boundary condition is used to describe a boundary condition of the corresponding computer model in CAE simulation. In the procedure shown in FIG. 1, the boundary condition may be generated after the geometric pre-processing.

The mesh information is used to describe a mesh division manner of the corresponding computer model. The mesh division manner is a division manner of dividing the computer model into a plurality of mesh cells. In the procedure shown in FIG. 1, the mesh information is completed in a mesh subdivision phase. The mesh information includes one or more of information such as mesh point coordinates and mesh division precision.

The physical equation is determined based on a to-be-solved physical problem.

The system of linear equations is obtained by performing numerical simulation on to-be-solved physical problem information. It can be learned that the system of linear equations is constructed based on the physical problem information. In other words, the physical problem information affects a subsequently generated system of linear equations, and the physical problem information used as upper-layer scenario information of the subsequently generated system of linear equations affects parameters such as a coefficient matrix and/or a right-hand side in the subsequently generated system of linear equations.

The following uses an example to describe a specific form of the description information.

In an example, a static charge distribution of a part (for example, a semiconductor material) in physical space needs to be solved using an electric potential Poisson equation. For example, the physical space including a related computer model is divided into 2704 mesh points.

A specific form of the electric potential Poisson equation is as follows:

$$∇ ( ε ( x , y ) ∇ φ ( x , y ) ) = - ρ ( x , y )$$

ε(x,y) represents a capacitance of a mesh point (x,y), φ(x,y) represents an electric potential of the mesh point (x,y), and ρ(x,y) represents a charge density of the mesh point (x,y).

After steps such as geometric pre-processing, boundary condition setting, mesh division, and physical equation setting performed on the computer model related to the part in the physical space in a CAD simulation scenario, description information such as to-be-solved physical problem information and information about a system of linear equations may be obtained.

In this case, the description information may include some or all of the following content.

1. Charge Density ρ(x,y) of Each of the 2704 Mesh Points.

The charge density ρ(x,y) of each of the 2704 mesh points may be described using a 2704×1 matrix. The matrix may be used as a right-hand side in the corresponding system of linear equations.

### 2. x and y Coordinates of Each of the 2704 Mesh Points.

The x and y coordinates of each of the 2704 mesh points may be described using a 5408×1 matrix. The matrix may be used as mesh information.

### 3. Physical Equation Information.

A quantity of physical equations related to the description information is not limited herein. There may be one physical equation, or may be a system of physical equations including a plurality of physical equations.

For example, the physical equation information may include one or more of the following content: (1) a physical equation in a mathematical form such as a system of PDEs, where the physical equation may include, for example, the foregoing electric potential Poisson equation, and (2) a physical parameter value in the physical equation, for example, a capacitance ε(x,y) of each of the 2704 mesh points.

The capacitance may be input by the user or preconfigured by a system. Inside a uniform medium, if the capacitance is a constant, the coefficient matrix in the system of linear equations is a constant, and the information about the system of linear equations in the description information may include only the right-hand side, and does not need to include the coefficient matrix. In a non-uniform medium, if the capacitance may be a function about a position, the information about the system of linear equations in the description information may include the coefficient matrix and the right-hand side.

### 4. Boundary Condition.

There may be a plurality of manners of describing the boundary condition. For example, the boundary condition may be described using mesh point information, or may be described in a form of an equation. The following separately uses examples for description.

### (1) the Boundary Condition is Described Using the Mesh Point Information.

For example, a 2704×1 matrix may be used for description. 2704 elements in the matrix are in one-to-one correspondence with 2704 mesh points, and a value of each element is 0 or 1. When a value of a specific element is 1, it indicates that a corresponding mesh point includes an electrode, in other words, the mesh point is a boundary point. When a value of a specific element is 0, it indicates that a corresponding mesh point is a non-boundary point. It can be learned that the matrix may indicate the boundary point in the corresponding computer model, to indicate the corresponding boundary condition.

### (2) the Boundary Condition is Described in the Form of the Equation.

For example, the boundary condition may be described using a Dirichlet condition:

$$φ ( x , y ) {\vert}_{x , y ∈ Ω} = {f}_{1} ( x , y ) , x ∈ \partial Ω$$

φ(x,y) represents the electric potential of the mesh point (x,y), Ω represents a domain of definition, f₁(x,y) represents a value of an electrode voltage, and a value of f₁(x,y) at the non-boundary point is 0.

Alternatively, the boundary condition may be described using a Neumann condition:

$$\frac{φ ( x , y ) {\vert}_{x , y ∈ Ω}}{\partial n} = {f}_{2} ( x , y ) , x ∈ \partial Ω$$

f₂(x,y) represents an electrode flux, a value of f₂(x,y) at the non-boundary point is 0, and n represents a normal vector of a plane ∂Ω.

In addition, in a CAE simulation process, after the geometric pre-processing, the boundary condition setting, and the mesh division is performed on the computer model, a discretized to-be-solved system of linear equations may be obtained based on the physical problem information such as the physical equation, the boundary condition, and/or the mesh information and using a method such as a finite volume method or a finite element method. That is, in this case, a coefficient matrix and a right-hand side in the to-be-solved system of linear equations may be determined.

In this way, information about the system of linear equations and the to-be-solved physical problem information such as the mesh information, the boundary condition, and/or the physical equation may be obtained as description information. The information about the system of linear equations in the description information may include the right-hand side. In addition, in some scenarios, the coefficient matrix may not be included. For example, if a material in the physical scenario is a uniform medium, and a corresponding capacitance is a constant, the coefficient matrix in the system of linear equations is a constant, and the information about the system of linear equations in the description information may include only the right-hand side, and does not need to include the coefficient matrix. In some other scenarios, the information about the system of linear equations may include the coefficient matrix. For example, if a material in the physical scenario is a non-uniform medium, and a corresponding capacitance may be a function about a position, the information about the system of linear equations in the description information may include the coefficient matrix and the right-hand side.

In some other scenarios, forms of the physical problem information and the information about the system of linear equations in the description information may be the same, or may be different.

For example, in another example, a relationship between a temperature and a pressure in a fluid in the physical space needs to be solved using a pressure Poisson equation.

A specific form of the pressure Poisson equation is as follows:

$$- \frac{1}{ρ} ( \frac{{\partial }^{2} p}{\partial {x}^{2}} + \frac{{\partial }^{2} p}{\partial {y}^{2}} ) = f ( x , y )$$

ρ represents a fluid density of the mesh point (x,y), p represents a pressure of the mesh point (x,y), and f(x,y) represents a temperature of the mesh point (x,y).

In this example, the boundary pressure is 0, that is:

$$p ( x , y ) = 0 , for ( x , y ) ∈ \partial Ω$$

Ω is the domain of definition, and p is the pressure.

In this example, in a manner the same as or similar to the foregoing manner, coordinates of each mesh point may alternatively be obtained as mesh information to obtain a physical equation, and coordinates of a boundary point may be further obtained as a boundary condition. Because the boundary pressure is 0, the boundary condition does not need to be further described using an equation or in another manner. In this way, physical problem information in this example can be obtained. Then, numerical simulation may be performed based on the physical problem information and using the finite element method or in another manner, to obtain a coefficient matrix and a right-hand side in a discretized system of linear equations as information about the system of linear equations.

It may be understood that, in this embodiment of this disclosure, a data form of description information may include one or more of forms such as a matrix, an equation, a vector, and a value.

It can be learned that, in this embodiment of this disclosure, the physical problem information is closely related to the constructed system of linear equations when being used as upper-layer scenario information used to construct the system of linear equations. Therefore, the description information may include the information about the system of linear equations and the physical problem information associated with the system of linear equations, such that in a subsequent processing process, the physical problem information and the information about the system of linear equations are used together as an input of the AI model, thereby helping the AI model mine useful scenario feature information and feature information of the system of linear equations from the physical problem information.

Step 402: Perform inference on the description information using the AI model, to obtain a first initial solution corresponding to the system of linear equations.

In this embodiment of this disclosure, a specific type of the AI model is not limited herein.

The AI model may be an existing model or a subsequently developed model. This is not limited in embodiments of this disclosure. For example, the AI model may be a general model such as a PINN or a CNN, or the AI model may be a model that can solve a PDE. For example, the AI model may be DeepONet, and both training and inference are used as a solving process.

For different AI models, processing performed on the description information may vary based on processing capabilities and requirements of the different AI models. For example, if the AI model is the PINN, and the PINN cannot well directly process input data in a form of a matrix, a physical equation, or the like, feature engineering may be performed on description information including the matrix and the physical equation. For example, the description information is encoded using a feature extraction model, or data form conversion (for example, conversion into data in a vector form) is performed on the description information, and encoded description information or description information obtained through the data form conversion is then input into the PINN. If the AI model is the DeepONet, description information including a form of a matrix, a physical equation, and/or the like may be received as input data.

In this embodiment of this disclosure, the AI model may be a trained model, such that the AI model can identify features of a system of linear equations based on input description information, to efficiently determine an appropriate initial solution of the system of linear equations.

In addition, in some embodiments, if the description information further includes the to-be-solved physical problem information, the AI model may identify features of physical problems and features of systems of linear equations in different physical scenarios, to determine initial solutions that are of the to-be-solved systems of linear equations and that are suitable for the different physical scenarios.

The AI model may be trained and completed in a computing device cluster, or may be transmitted and deployed to the computing device cluster after being trained and completed in another device.

The following describes an example of a training process of the AI model.

In this embodiment of this disclosure, the training process may include one or more of the following steps.
1. Obtain a dataset. The dataset includes a plurality of samples and a label corresponding to each sample. Any sample may include a physical equation, a boundary condition, mesh information, a coefficient matrix, and a right-hand side. The label corresponding to the sample includes a corresponding initial solution, and may further include a performance indicator of a corresponding solving process. The performance indicator may include one or more of solving duration, solving precision, and a quantity of iterations.

A collection manner of the dataset is not limited herein. For example, the dataset may be obtained from an open source dataset, or the dataset may be generated by manually collecting information for iteratively solving systems of linear equations in various different scenarios.
2. Preprocess training data of the dataset.

A manner of the preprocessing is not limited herein. For example, the preprocessing may include one or more of the following manners:
(1) Data cleansing: including checking and processing a missing value, an abnormal value, and data that fails to be solved in the dataset, to ensure quality and accuracy of the description information.
(2) Data integration: A plurality of data sources is combined into one dataset, to solve inconsistency and duplication problems between the data sources.
(3) Data conversion: A process of converting the samples into samples in a form suitable for the AI model includes operations such as data standardization, normalization, and discretization.
(4) Data specification: A process of reducing a dataset scale can be implemented through clustering, sampling, feature extraction, and other methods, to train the AI models more quickly and reduce storage overheads.
(5) Feature engineering: Perform feature extraction, conversion, and selection on the samples, to better train the AI model.
3. Classify the dataset into a training set and a validation set.
4. Train one to-be-trained model or a plurality of to-be-trained models based on the training set, to obtain a trained model.

When there are the plurality of to-be-trained models, types and structures of different to-be-trained models may be the same, similar, or different.

In the training process, a parameter of the to-be-trained model in an iteration process may be updated based on a loss function. A specific form of the loss function is not limited herein.

In an example, the loss function may be used to evaluate a difference between a training initial solution output by the to-be-trained model in the iteration process and the initial solution in the label of the corresponding sample, and may further reflect a performance indicator in the label of the corresponding sample.

In the iteration process, the difference between the training initial solution output by the to-be-trained model and the initial solution in the label of the corresponding sample is positively correlated with a loss value. In other words, a larger difference between the training initial solution output by the to-be-trained model in the iteration process and the initial solution in the label of the corresponding sample usually indicates a larger corresponding loss value. The performance indicator in the label of the corresponding sample means that corresponding poorer solving performance (for example, longer solving duration, lower solving precision, and a larger quantity of iterations) indicates a corresponding larger loss value.

In this way, one or more trained models may be obtained based on the training set and the loss function.
5. Verify the one or more trained models using the verification set, and obtain an optimal model as the AI model through screening.
6. Deploy the obtained AI model to the computing device cluster.

After the obtained AI model is deployed to the computing device cluster, description information may be processed using the AI model, to obtain a first initial solution corresponding to a system of linear equations.

After the preprocessing such as the data conversion and/or the feature engineering is performed on the description information, preprocessed description information may be input into the AI model, to determine, using the AI model, the first initial solution that meets the features of the current physical scenario and that is suitable for the current to-be-solved system of linear equations.

Step 403: Determine a target initial solution based on the first initial solution, and iteratively solve the system of linear equations based on the target initial solution, to output a solving result of the system of linear equations.

In this embodiment of this disclosure, after the first initial solution is obtained, the first initial solution may be used as the target initial solution of the system of linear equations, to iteratively solve the system of linear equations, to obtain the solving result of the system of linear equations, or after the first initial solution is obtained, a better target initial solution may be further queried based on the first initial solution, to iteratively solve the system of linear equations based on the better target initial solution, to obtain the solving result of the system of linear equations.

In this embodiment of this disclosure, a functional module that implements an initial solution screening process in the computing device cluster is referred to as an initial solution adaptive optimization module.

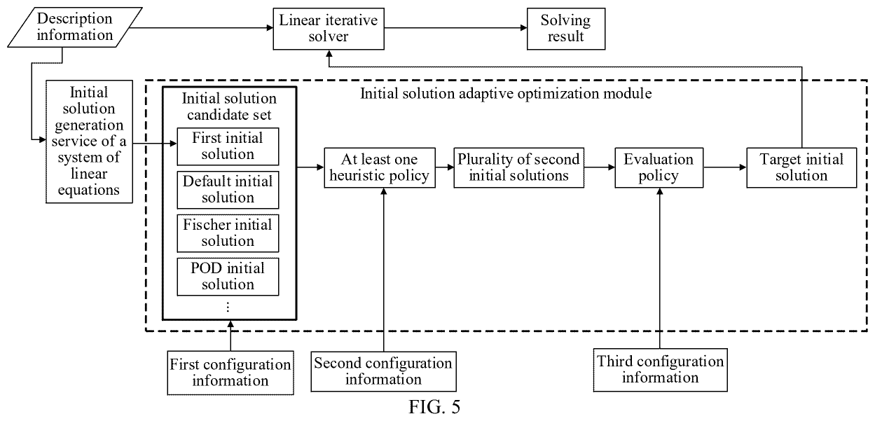

FIG. 5 is an example diagram of iteratively solving a system of linear equations by an initial solution adaptive optimization module. The following uses the initial solution adaptive optimization module in FIG. 5 as an example to describe a further initial solution screening process after a first initial solution is obtained. In an actual implementation process, the initial solution adaptive optimization module may be implemented using one or more cloud services of a cloud management platform. This is not limited in embodiments of this disclosure.

As shown in FIG. 5, the initial solution screening process may include one or a combination of more of the following steps.

1. Obtain an Initial Solution Candidate Set, to Select a Target Initial Solution from the Initial Solution Candidate Set.

In some embodiments, step 401 includes obtaining first configuration information, where the first configuration information carries at least one initial solution generation manner used to generate an initial solution, obtaining a plurality of initial solutions in the at least one initial solution generation manner indicated by the first configuration information, where the plurality of initial solutions includes the first initial solution, selecting the target initial solution from the plurality of initial solutions, and iteratively solving the system of linear equations based on the target initial solution, to output a solving result of the system of linear equations.

In this embodiment of this disclosure, the cloud management platform may provide a first configuration interface, and a plurality of preset initial solution generation manners is displayed on the first configuration interface. A user may select the plurality of initial solution generation manners from the first configuration interface and perform confirmation. In this way, the user may input the first configuration information to the cloud management platform. That is, the first configuration information is configured and input by the user.

Alternatively, on the cloud management platform, a developer may preconfigure, based on expert experience or the like, the plurality of initial solution generation manners in the cloud service provided for the user. That is, in this example, the first configuration information may be preconfigured by the developer in the related cloud service.

The first configuration information indicates the at least one initial solution generation manner, and each initial solution generation manner corresponds to one initial solution of the system of linear equations. In this way, a plurality of initial solutions may be obtained in the at least one initial solution generation manner.

Specific content of the at least one initial solution generation manner is not limited herein.

The at least one initial solution generation manner includes a manner of generating an initial solution using an AI model. That is, in this embodiment of this disclosure, a manner of generating the first initial solution through the foregoing steps 401 and 402 is included.

In addition, for example, in the example shown in FIG. 5, the plurality of initial solution generation manners may further include one or more of the following manners: (1) a default initial solution, (2) an initial solution obtained using a Fischer algorithm, and (3) an initial solution obtained using a POD algorithm.

The plurality of initial solutions may be included in the initial solution candidate set. After the plurality of initial solutions is obtained, the target initial solution may be selected from the plurality of initial solutions using a search algorithm and/or an evaluation indicator and/or in another manner.

In this embodiment of this disclosure, considering that different initial solution generation manners may be suitable for physical problems in different physical scenarios, the plurality of initial solutions may be provided based on the first configuration information. In this way, adaptation degrees of different initial solution generation manners in different physical problems may be fully considered, and a more appropriate target initial solution in the physical problem of a current category is selected from the plurality of initial solutions, such that quality of the finally obtained target initial solution is improved, thereby improving solving efficiency of an iterative solving process of the system of linear equations.

### 2. Screen the Plurality of Initial Solutions in the Initial Solution Candidate Set According to a Heuristic Policy, to Obtain the Target Initial Solution.

In some embodiments, selecting the target initial solution from the plurality of initial solutions includes obtaining second configuration information, where the second configuration information carries at least one heuristic policy, and selecting the target initial solution from the plurality of initial solutions according to the at least one heuristic policy.

In this embodiment of this disclosure, the cloud management platform may provide a second configuration interface, and a plurality of preset heuristic policies is displayed on the second configuration interface. The user may select at least one heuristic policy from the second configuration interface and perform confirmation. In this way, the user may input the second configuration information to the cloud management platform. That is, the second configuration information is configured by the user.

A quantity and types of preset heuristic policies on the second configuration interface are not limited herein.

For example, the preset heuristic policy on the second configuration interface may include one or more of the following policies: a greedy search algorithm, a simulated annealing algorithm, a genetic algorithm, and a particle swarm optimization algorithm.

Alternatively, on the cloud management platform, the developer may preconfigure, based on the experience or the like, the target heuristic policy in the cloud service provided for the user. That is, in this example, the second configuration information may be preconfigured by the developer in the related cloud service.

A specific type of the at least one heuristic policy is not limited herein either.

That the second configuration information carries the at least one heuristic policy may mean that the second configuration information carries information such as an identifier and/or a related operator of the at least one heuristic policy. In this way, the cloud management platform may screen the plurality of initial solutions based on the second configuration information according to the at least one heuristic policy.

A specific process of selecting the target initial solution from the plurality of initial solutions according to the at least one heuristic policy is not limited herein. For example, the plurality of initial solutions may be screened according to a heuristic policy, or multi-level screening may be performed on the plurality of initial solutions according to a plurality of heuristic policies. For example, preliminary screening may be performed on the plurality of initial solutions using the greedy search algorithm, and then initial solutions obtained through the preliminary screening are further screened using the genetic algorithm.

The plurality of initial solutions is screened according to the at least one heuristic policy, such that one or more initial solutions may be selected from the plurality of initial solutions. For ease of description, in this embodiment of this disclosure, the initial solution selected from the plurality of initial solutions according to the at least one heuristic policy is referred to as a second initial solution. There may be one second initial solution or a plurality of second initial solutions.

If the plurality of initial solutions is screened according to the target heuristic policy, and one second initial solution may be directly selected from the plurality of initial solutions, the second initial solution may be used as the target initial solution. If the plurality of initial solutions is screened according to the target heuristic policy, and the plurality of second initial solutions may be selected from the plurality of initial solutions (for example, in the example shown in FIG. 5, there may be the plurality of second initial solutions), the plurality of second initial solutions may be further screened, to select a better target initial solution from the plurality of second initial solutions.

In this embodiment of this disclosure, the plurality of initial solutions is screened according to the target heuristic policy, such that a part of initial solutions that better meet features of the current physical problem can be selected from the plurality of initial solutions as the second initial solution, and the more appropriate target initial solution can be obtained through screening in the physical problem of the current category, thereby improving quality of the finally obtained target initial solution.

3. Select the Target Initial Solution from the Plurality of Initial Solutions According to an Evaluation Policy.

In some embodiments, selecting the target initial solution from the plurality of initial solutions includes obtaining third configuration information, where the third configuration information carries the evaluation policy, the evaluation policy includes an evaluation indicator, or includes an evaluation indicator and a weight corresponding to each evaluation indicator, and the evaluation indicator includes one or more of solving duration, solving precision, and a quantity of iterations, and selecting the target initial solution from the plurality of initial solutions according to the evaluation policy.

In this embodiment of this disclosure, the cloud management platform may provide a third configuration interface. On the third configuration interface, a plurality of preset evaluation indicators is displayed, and a weight configuration item of each preset evaluation indicator may be further displayed. The user may select one or more evaluation indicators from the third configuration interface, or may configure, using a weight configuration item of the selected evaluation indicator, a weight corresponding to the corresponding evaluation indicator. In this way, the user may input the third configuration information to the cloud management platform. That is, the third configuration information is configured and input by the user.

Alternatively, on the cloud management platform, a developer may preconfigure, based on the experience or the like, the evaluation indicator in the cloud service provided for the user, and further configure a weight corresponding to each evaluation indicator. That is, in this example, the third configuration information may be preconfigured by the developer in the related cloud service.

The third configuration information may carry an identifier of the evaluation policy, or may carry content of the evaluation policy, for example, carry an evaluation indicator and a weight corresponding to each evaluation indicator.

The evaluation indicator included in the evaluation policy may include one or more of the following indicators: solving duration, solving precision, and a quantity of iterations.

The solving duration is duration needed in an iterative solving process when the corresponding second initial solution is used as the initial solution in the iterative solving process of the system of linear equations.

The solving precision is precision of the solving result obtained through iterative solving when the corresponding second initial solution is used as the initial solution in the iterative solving process of the system of linear equations. The precision may describe a difference between the solving result and an accurate solving result of the system of linear equations.

The quantity of iterations is a quantity of iterations performed in the iterative solving process when the corresponding second initial solution is used as the initial solution in the iterative solving process of the system of linear equations.

The weight corresponding to each evaluation indicator may be configured by the user, or may be preconfigured by the developer or the like.

It may be understood that any evaluation indicator may be used to evaluate iteration performance when the corresponding initial solution is used as the initial solution in the iterative solving process of the system of linear equations. In this way, the corresponding target initial solution with good iteration performance may be selected from the plurality of initial solutions based on the information such as the evaluation indicator and the related weight in the evaluation policy.

In this embodiment of this disclosure, when the target initial solution is selected from the plurality of initial solutions according to the evaluation policy, the target initial solution may be directly selected from the plurality of initial solutions according to the evaluation policy, or in the example shown in FIG. 5, after the plurality of second initial solutions is selected from the plurality of initial solutions according to the at least one heuristic policy, the target initial solution is selected from the plurality of second initial solutions according to the evaluation policy.

That is, the foregoing three methods of the initial solution screening process may be applied in combination, or may be applied separately. The initial solution screening process in this embodiment of this disclosure may be performed in a plurality of manners. This is not limited herein.

In this embodiment of this disclosure, the AI model may be used to mine feature information of the system of linear equations, to efficiently determine the appropriate initial solution of the current system of linear equations, thereby improving solving efficiency of the system of linear equations, and avoiding a generalization problem caused by an initial solution determined based on the expert experience and the default initial solution.

In addition, algorithms for determining the initial solution of the system of linear equations are usually used to predict the initial solution of the system of linear equations in a mathematical derivation manner, and are, for example, a POD algorithm and a Fischer algorithm.

Only information about a coefficient matrix in the system of linear equations is usually considered for these algorithms for determining the initial solution of the system of linear equations, but features of a to-be-solved problem cannot be well reflected based only on the coefficient matrix in the system of linear equations. Therefore, there is usually a large deviation in an effect of the initial solution predicted using these algorithms for determining the initial solution of the system of linear equations, and appropriate initial solutions cannot be provided for various scenarios.

However, in some examples of this disclosure, description information may include not only information about the system of linear equations, but also to-be-solved physical problem information. In this way, the AI model can fully mine solving information of the physical problem in a current physical scenario and the information about the system of linear equations, such that the initial solution can be fully determined for the current to-be-solved system of linear equations based on multi-dimensional features. Therefore, requirements of a plurality of application scenarios can be met. For example, appropriate initial solutions can be efficiently provided for to-be-solved systems of linear equations in various engineering application scenarios.

In this embodiment of this disclosure, the description information may be processed using the AI model.

The description information includes multi-dimensional features such as a plurality of aspects of information such as the information about the system of linear equations and the physical problem information associated with the system of linear equations. The AI model is a trained model, and has a capability of identifying features of physical problems in different physical scenarios and the features of the system of linear equations, such that the first initial solution that meets features of the current application scenario and that is suitable for the current to-be-solved system of linear equations can be determined based on the multi-dimensional features of the current to-be-solved physical problem extracted from the input description information.

It can be learned that, according to this embodiment of this disclosure, appropriate initial solutions can be efficiently provided for systems of linear equations corresponding to physical problems in different scenarios, to improve speeds of iteratively solving the systems of linear equations, obtain corresponding solving results more quickly, and improve efficiency of solving the corresponding systems of linear equations.

In addition, in some embodiments, after the solving result is obtained, the AI model may be further optimized based on the solving result, to improve performance of the AI model, such that the AI model can better adapt to a requirement of an actual application scenario.

In some embodiments, the method further includes generating training data, where the training data includes a training sample and a label corresponding to the training sample, the training sample includes the description information, and the label corresponding to the training sample is obtained based on the first initial solution, and training the AI model based on the training data, to obtain an optimized AI model.

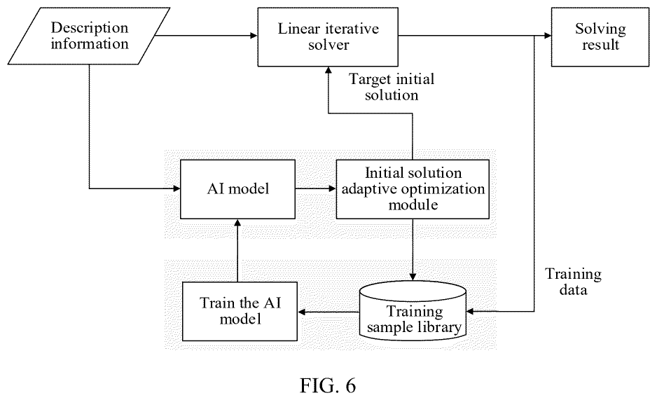

FIG. 6 is an example diagram of iteratively solving a system of linear equations according to an embodiment of this disclosure.

It can be learned that, in this embodiment of this disclosure, target initial solutions corresponding to different systems of linear equations may be collected. In addition, in some examples, target initial solutions corresponding to systems of linear equations in different physical problem scenarios in an actual application scenario may be further collected, and related performance data of actual iterative solving results is obtained, such that whether the corresponding target initial solutions are appropriate initial solutions can be well determined, and corresponding training data can be generated.

Then, an AI model may be trained based on the training data to obtain an optimized AI model, and a subsequent method for solving a system of linear equations is then performed based on the optimized AI model.

In this way, the AI model may be continuously iteratively updated with a change of user data distribution and a scale in the actual application scenario for continuous optimization, such that the optimized AI model better adapts to a requirement of the current scenario, and can generate better initial solutions for different physical problems and corresponding systems of linear equations, thereby improving solving efficiency.

In some embodiments, the method further includes obtaining a performance indicator corresponding to the solving result, where the performance indicator includes one or more of solving duration, solving precision, and a quantity of iterations, and training the AI model based on the training data, to obtain the optimized AI model includes training the AI model based on the training data and a loss function, to obtain the optimized AI model, where the loss function is constructed based on the performance indicator.

In embodiments of this disclosure, a specific form of the loss function is not limited herein.

In an example, the loss function may reflect a performance indicator in a label of a corresponding sample.

The performance indicator may be obtained through a solving process of a corresponding solving result. For example, a quantity of iterations in the solving process may be used as a performance indicator, and solving duration of the solving process may also be used as a performance indicator. In addition, a difference between the target initial solution and an accurate initial solution of the system of linear equations may be further calculated, to obtain corresponding solving precision, which is used as a performance indicator. For example, the target initial solution x0 may be substituted into the system of linear equations Ax=b, and a difference between b and Ax0 is then calculated. The difference may be considered as a residual corresponding to the target initial solution, and may reflect corresponding solving precision.

The performance indicator in the label of the corresponding training sample means that corresponding poorer solving performance (for example, longer solving duration, lower solving precision, and a larger quantity of iterations) indicates a corresponding larger loss value.

In addition, the loss function may be further used to evaluate a difference between a training initial solution output by a to-be-trained model in an iteration process and an initial solution in a label of a corresponding sample.

In the iteration process, the difference between the training initial solution output by the to-be-trained model and the initial solution in the label of the corresponding sample is positively correlated with the loss value. In other words, a larger difference between the training initial solution output by the to-be-trained model in the iteration process and the initial solution in the label of the corresponding sample usually indicates a larger corresponding loss value.

In this embodiment of this disclosure, the loss function is constructed based on the performance indicator, such that the AI model can be optimized in a direction of a better performance indicator in a training process, to help improve performance of the AI model.

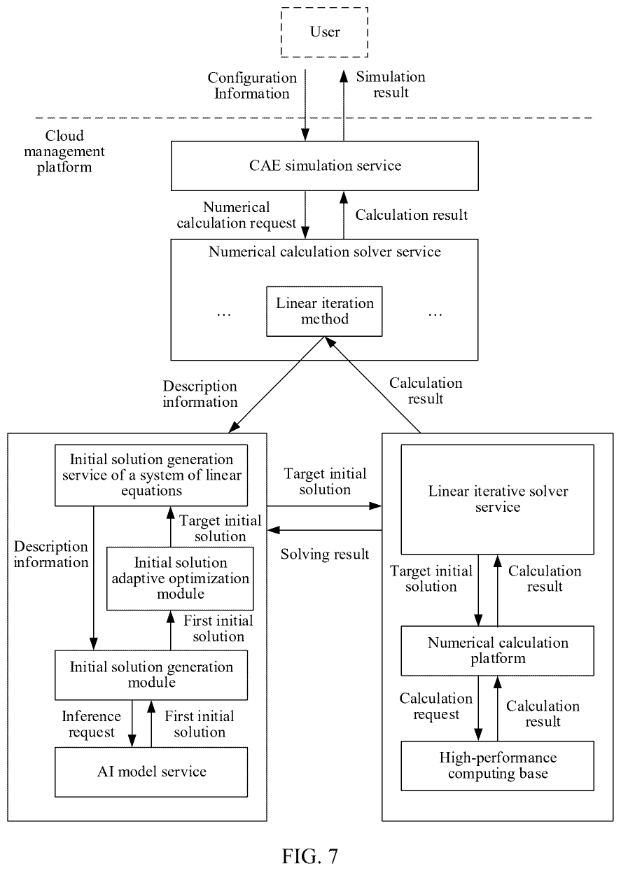

It can be learned that, based on the descriptions of the foregoing embodiment, an example specific implementation of the initial solution generation service for linear iteration and the linear iterative solver service shown in FIG. 3 is shown in FIG. 7.

In an example shown in FIG. 7, the initial solution generation service of a system of linear equations may invoke, using an initial solution generation module, an AI model in an AI model service to process description information, to obtain a first initial solution. Then, an initial solution adaptive optimization module may obtain a target initial solution through screening based on an initial solution candidate set including the first initial solution according to a target heuristic policy, an evaluation policy, and the like. Then, the initial solution generation service of the system of linear equations may send the target initial solution to the linear iterative solver service, such that the linear iterative solver invokes, via a data computing platform, a resource of a high-performance computing base to iteratively solve the system of linear equations based on the target initial solution, to obtain a calculation result of the system of linear equations.

The following uses an example to describe a specific application process of the method for solving a system of linear equations in this embodiment of this disclosure in the engineering field.

In an example, electromagnetic performance optimization simulation of a solenoid valve needs to be implemented. The electromagnetic performance optimization simulation of the solenoid valve belongs to two-dimensional low-frequency electromagnetic nonlinear simulation.

The solenoid valve is an axisymmetric model, and solving calculation may be performed using a two-dimensional axisymmetric computer model. Through solving, core electromagnetic performance parameters such as a magnetic density, a current density, a loss, a current, a voltage, inductance, back electromotive force, corresponding time, a response acceleration, and valve core (plunger) electromagnetic force may be obtained, to comprehensively evaluate, analyze, design, and optimize electromagnetic performance of the solenoid valve.

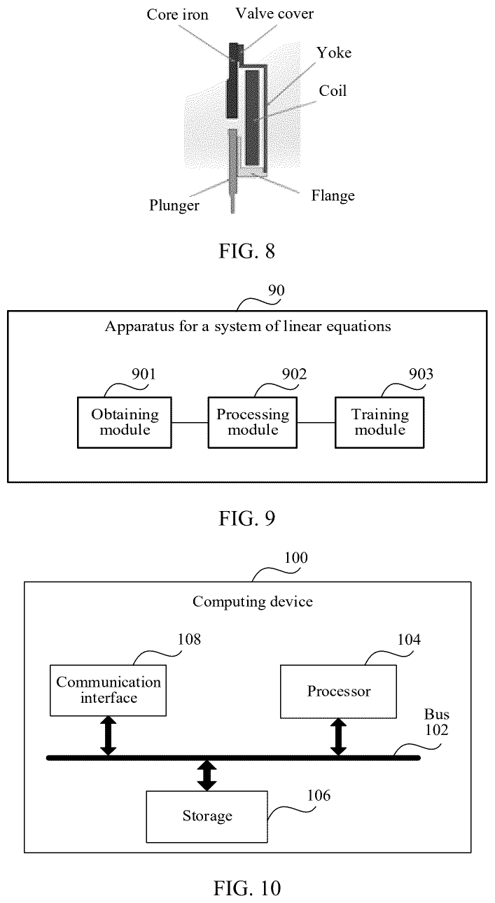

FIG. 8 is a diagram of an example of a two-dimensional axisymmetric computer model of a solenoid valve.

Based on the computer model, electromagnetic performance optimization simulation of the solenoid valve can be solved. In this scenario, a Newton iteration method may be used for a to-be-solved nonlinear physical problem, and in each nonlinear iteration process, a system of linear equations may be constructed for solving.

In this case, a target initial solution of the system of linear equations in each nonlinear iteration process may be obtained using an AI model. The AI model may be trained in advance based on a historical training dataset. The historical training dataset includes a training sample in an electromagnetic performance optimization simulation scenario of the solenoid valve and an initial solution label corresponding to the training sample, and the training sample in the electromagnetic performance optimization simulation scenario of the solenoid valve includes a boundary condition, mesh information, and a physical equation of a historical computer model in the electromagnetic performance optimization simulation scenario of the solenoid valve.

Therefore, the AI model obtained through training using the historical training dataset has a capability of providing an appropriate first initial solution of a to-be-solved system of linear equations in the electromagnetic performance optimization simulation scenario of the solenoid valve.

In each nonlinear iteration process, information about a system of linear equations in the current nonlinear iteration process and physical problem information such as a boundary condition, mesh information, and a physical equation that correspond to the system of linear equations may be obtained, and after the information about the system of linear equations and the corresponding physical problem information are preprocessed, preprocessed information about the system of linear equations and corresponding physical problem information are input into the AI model, to obtain a first initial solution of the system of linear equations in the current nonlinear iteration process.

Next, a default initial solution, an initial solution obtained based on a Fischer algorithm, and an initial solution obtained based on a POD algorithm may be obtained based on first configuration information. In this way, an initial solution candidate set may be obtained. The initial solution candidate set includes the first initial solution, the default initial solution, the initial solution obtained based on the Fischer algorithm, and the initial solution obtained based on the POD algorithm.

Still, a plurality of second initial solutions is selected from the initial solution candidate set based on second configuration information configured by a user and according to a target heuristic rule. Then, a score of each second initial solution may be calculated based on an evaluation indicator configured by the user and a weight corresponding to each evaluation indicator, and an optimal initial solution is selected as a target initial solution from the plurality of second initial solutions based on the score of each second initial solution. The target initial solution is used as a target initial solution of the system of linear equations in the current nonlinear iteration process, to iteratively solve the system of linear equations, to obtain a solving result of the system of linear equations in the current nonlinear iteration process.

It can be learned that, in each nonlinear iteration process, the foregoing method for solving a system of linear equations may be used until an iteration termination condition for nonlinear iteration is met, and a final solving result of a to-be-solved nonlinear physical problem is obtained.

In a specific implementation process of this example, mesh division precision of two computer models may be used. Regardless of which mesh division precision is used, in each nonlinear iteration process, when the foregoing method for solving a system of linear equations is used to obtain the target initial solution to solve the system of linear equations, both a solving duration and a quantity of linear iterations are less than those used when another manner is used to obtain the target initial solution to solve the system of linear equations.

It can be learned that, in this example, the target initial solution is obtained using the foregoing method for solving a system of linear equations to solve the system of linear equations, such that the more appropriate target initial solution can be provided for the to-be-solved system of linear equations, to significantly improve a solving speed of an entire nonlinear iteration process.

The foregoing describes, from a plurality of aspects, the method for solving a system of linear equations provided in embodiments of this disclosure. The following describes, with reference to the accompanying drawings, an apparatus for solving a system of linear equations provided in embodiments of this disclosure.

As shown in FIG. 9, an embodiment of this disclosure provides an apparatus 90 for solving a system of linear equations. The apparatus 90 for solving a system of linear equations includes an obtaining module 901 configured to obtain description information input by a user, where the description information includes information about a system of linear equations, and the information about the system of linear equations includes a right-hand side, and a processing module 902 configured to perform inference on the description information using an AI model, to obtain a first initial solution corresponding to the system of linear equations, and determine a target initial solution based on the first initial solution, and iteratively solve the system of linear equations based on the target initial solution, to output a solving result of the system of linear equations.

Optionally, the description information further includes to-be-solved physical problem information, the system of linear equations is obtained by performing numerical simulation on the to-be-solved physical problem information, and the to-be-solved physical problem information includes at least one of the following: a boundary condition, mesh information, and a physical equation.

Optionally, the obtaining module 901 is configured to obtain first configuration information, where the first configuration information carries at least one initial solution generation manner used to generate an initial solution.

The processing module 902 is configured to obtain a plurality of initial solutions in the at least one initial solution generation manner indicated by the first configuration information, where the plurality of initial solutions includes the first initial solution, select the target initial solution from the plurality of initial solutions, and iteratively solve the system of linear equations based on the target initial solution, to output the solving result of the system of linear equations.

Optionally, the obtaining module 901 is configured to obtain second configuration information, where the second configuration information carries at least one heuristic policy.

The processing module 902 is configured to select the target initial solution from the plurality of initial solutions according to the at least one heuristic policy.

Optionally, the obtaining module 901 is configured to obtain third configuration information, where the third configuration information carries an evaluation policy, the evaluation policy includes an evaluation indicator, or includes an evaluation indicator and a weight corresponding to each evaluation indicator, and the evaluation indicator includes one or more of solving duration, solving precision, and a quantity of iterations.

The processing module 902 is configured to select the target initial solution from the plurality of initial solutions according to the evaluation policy.

Optionally, the apparatus 90 further includes a training module 903.

The training module 903 is configured to generate training data, where the training data includes a training sample and a label corresponding to the training sample, the training sample includes the description information, and the label corresponding to the training sample is obtained based on the first initial solution, and train the AI model based on the training data, to obtain an optimized AI model.

Optionally, the obtaining module 901 is further configured to obtain a performance indicator corresponding to the solving result, where the performance indicator includes one or more of solving duration, solving precision, and a quantity of iterations.

The training module 903 is configured to train the AI model based on the training data and a loss function, to obtain the optimized AI model, where the loss function is constructed based on the performance indicator.

Optionally, the AI model is a general model or a model used to solve a PDE, the general model includes a CNN or a PINN, and the model used to solve the PDE includes DeepONet.

In some examples, the obtaining module 901 may implement interaction with the user, and the processing module 902 may perform some or all of the steps in the initial solution generation service for linear iteration and the linear iterative solver service in any one of the foregoing method embodiments. The training module may perform steps such as training and optimization of the AI model in the initial solution generation service for linear iteration in any one of the foregoing method embodiments.

In this embodiment of this disclosure, the module is used as an example of a software functional unit, and the apparatus for solving a system of linear equations may include code running on a computing instance. The computing instance may be at least one of computing devices such as a physical host (computing device), a virtual machine, and a container. Further, there may be one or more computing devices. For example, the apparatus for solving a system of linear equations may include code running on a plurality of hosts/virtual machines/containers. It should be noted that the plurality of hosts/virtual machines/containers configured to run the code may be distributed in a same region or may be distributed in different regions. A plurality of hosts/virtual machines/containers configured to run the code may be distributed in a same availability zone (AZ), or may be distributed in different AZs. Each AZ includes one data center or a plurality of data centers that is geographically close to each other. Usually, one region may include a plurality of AZs.

Similarly, the plurality of hosts/virtual machines/containers configured to run the code may be distributed in a same virtual private cloud (VPC), or may be distributed in a plurality of VPCs. Usually, one VPC is disposed in one region. A communication gateway needs to be disposed in each VPC for communication between two VPCs in a same region or between VPCs in different regions. Interconnection between VPCs is implemented via the communication gateway.

The module is used as an example of a hardware functional unit, and the apparatus for solving a system of linear equations may include at least one computing device, for example, a server. Alternatively, the apparatus for solving a system of linear equations may be a device implemented using an application-specific integrated circuit (ASIC) or a programmable logic device (PLD). The PLD may be a complex PLD (CPLD), a field-programmable gate array (FPGA), generic array logic (GAL), or any combination thereof.

A plurality of computing devices included in the apparatus for solving a system of linear equations may be distributed in a same region, or may be distributed in different regions. The plurality of computing devices included in the apparatus for solving a system of linear equations may be distributed in a same AZ, or may be distributed in different AZs. Similarly, the plurality of computing devices included in the apparatus for solving a system of linear equations may be distributed in a same VPC, or may be distributed in a plurality of VPCs. The plurality of computing devices may be any combination of computing devices such as the server, the ASIC, the PLD, the CPLD, the FPGA, and the GAL.

It should be noted that, in another embodiment, the obtaining module may be configured to perform any step in the method for solving a system of linear equations, the processing module may be configured to perform any step in the method for solving a system of linear equations, and the training module may be configured to perform any step in the method for solving a system of linear equations. Steps implemented by the obtaining module, the processing module, and the training module may be specified based on a requirement. The obtaining module, the processing module, and the training module respectively implement different steps in the method for solving a system of linear equations, to implement all functions of the apparatus for solving a system of linear equations.

An embodiment of this disclosure further provides a computing device 100. As shown in FIG. 10, the computing device 100 includes a bus 102, a processor 104, a storage 106, and a communication interface 108. The processor 104, the storage 106, and the communication interface 108 communicate with each other via the bus 102. The computing device 100 may be a server or a terminal device. It should be understood that a quantity of processors and a quantity of storages in the computing device 100 are not limited in this disclosure.

The bus 102 may be a PCI bus, an Extended Industry Standard Architecture (EISA) bus, or the like. The bus may be classified into an address bus, a data bus, a control bus, and the like. For ease of representation, only one line is used to represent the bus in FIG. 10, but this does not mean that there is only one bus or only one type of bus. The bus 102 may include a path for transmitting information between various components (for example, the storage 106, the processor 104, and the communication interface 108) of the computing device 100.

The processor 104 may include any one or more of processors such as a central processing unit (CPU), a graphics processing unit (GPU), a microprocessor (MP), or a digital signal processor (DSP).

The storage 106 may include a volatile memory, for example, a random-access memory (RAM). The processor 104 may further include a non-volatile memory, for example, a read-only memory (ROM), a flash memory, a hard disk drive (HDD), or a solid-state drive (SSD).

The storage 106 stores executable program code, and the processor 104 executes the executable program code to separately implement functions of the foregoing obtaining module, processing module, and/or training module, to implement the method for solving a system of linear equations applied to a computing device cluster in the foregoing embodiments. That is, the storage 106 stores instructions used to perform the method for solving a system of linear equations applied to a computing device cluster in the foregoing embodiments.

The communication interface 108 uses a transceiver module, for example, but not limited to, a network interface card or a transceiver, to implement communication between the computing device 100 and another device or a communication network.

An embodiment of this disclosure further provides a computing device cluster. The computing device cluster includes at least one computing device. The computing device may be a server, for example, a central server, an edge server, or a local server in a local data center. In some embodiments, the computing device may alternatively be a terminal device, for example, a desktop computer, a notebook computer, or a smartphone.

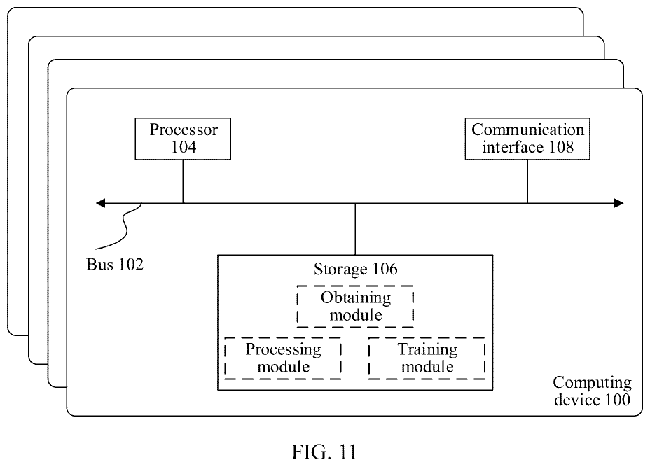

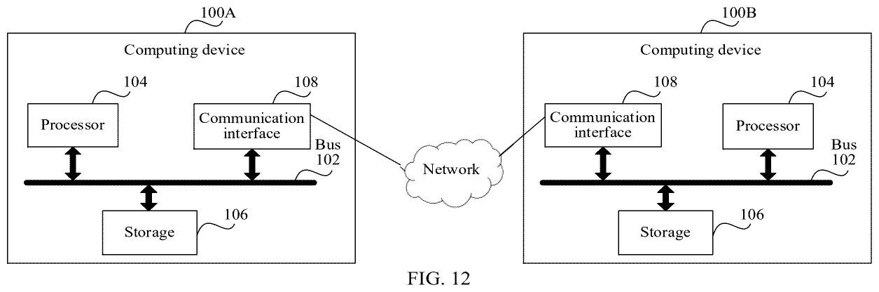

As shown in FIG. 11, the computing device cluster includes at least one computing device 100. A storage 106 in one or more computing devices 100 in the computing device cluster may store same instructions used to perform a method for solving a system of linear equations.

In some possible implementations, the storage 106 in the one or more computing devices 100 in the computing device cluster each may alternatively separately store some instructions used to perform the method for solving a system of linear equations. In other words, a combination of the one or more computing devices 100 may jointly execute instructions used to perform the method for solving a system of linear equations.

It should be noted that storages 106 in different computing devices 100 in the computing device cluster may store different instructions, which are respectively used to perform a part of functions of the method for solving a system of linear equations. In other words, the instructions stored in the storages 106 in the different computing devices 100 may implement functions of one or more of an obtaining module, a processing module, and a training module.

In some possible implementations, the one or more computing devices in the computing device cluster may be connected through a network. The network may be a wide area network, a local area network, or the like. FIG. 12 shows a possible implementation. As shown in FIG. 12, two computing devices 100A and 100B are connected through a network. The computing devices are connected to the network through communication interfaces of the computing devices. In this possible implementation, a storage 106 in the computing device 100A may store instructions for performing a function of an obtaining module, and a storage 106 in the computing device 100B may store instructions for performing a function of a processing module. Alternatively, a storage 106 in the computing device 100A may store instructions for performing a part of functions of a training module, and a storage 106 in the computing device 100B may store instructions for performing another part of functions of the processing module.

It should be understood that a function of the computing device 100A shown in FIG. 12 may alternatively be completed by a plurality of computing devices 100. Similarly, a function of the computing device 100B may alternatively be completed by the plurality of computing devices 100.

An embodiment of this disclosure further provides another computing device cluster. For a connection relationship between computing devices in the computing device cluster, refer to the connection manner of the computing device cluster in FIG. 11 and FIG. 12 similarly. A difference lies in that a storage 106 in one or more computing devices 100 in the computing device cluster may store same instructions used to perform a method for solving a system of linear equations.

In some possible implementations, the storage 106 in the one or more computing devices 100 in the computing device cluster each may alternatively separately store some instructions used to perform the method for solving a system of linear equations. In other words, a combination of the one or more computing devices 100 may jointly execute instructions used to perform the method for solving a system of linear equations.

It should be noted that storages 106 in different computing devices 100 in the computing device cluster may store different instructions, which are used to perform a part of functions of a method for solving a system of linear equations. In other words, the instructions stored in the storages 106 in the different computing devices 100 may implement functions of one or more of an obtaining module, a processing module, and a training module.

An embodiment of this disclosure further provides a computer program product including instructions. The computer program product may be a software or program product that includes instructions and that can be run on a computing device or stored in any usable medium. When the computer program product runs on at least one computing device, the at least one computing device is caused to perform a method for solving a system of linear equations.

An embodiment of this disclosure further provides a computer-readable storage medium. The computer-readable storage medium may be any usable medium that can be stored by a computing device or a data storage device such as a data center integrating one or more usable media. The usable medium may be a magnetic medium (for example, a floppy disk, a hard disk, or a magnetic tape), an optical medium (for example, a DIGITAL VERSATILE DISC (DVD)), a semiconductor medium (for example, a solid-state drive), or the like. The computer-readable storage medium includes instructions, and the instructions instruct the computing device to perform a method for solving a system of linear equations.

An embodiment of this disclosure further provides a chip system. The chip system includes a processor, and the processor is configured to implement steps performed by the foregoing computing device cluster. In a possible design, the chip system may further include a storage. The storage is configured to store necessary program instructions and data. The chip system may include a chip, or may include a chip and another discrete device.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this disclosure, it should be understood that the disclosed system, apparatus, and method may be implemented in other manners. For example, the apparatus embodiments described above are merely examples. For example, division into units is merely logical function division, and may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, that is, may be located in one position, or may be distributed on a plurality of network units. Some or all of the units may be selected based on an actual requirement to achieve the objectives of the solutions of embodiments.

In addition, functional units in embodiments of this disclosure may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions in this disclosure essentially, or the part contributing to the technology, or all or some of the technical solutions may be implemented in a form of a software product. The computer software product is stored in a storage medium, and includes several instructions for indicating a computer device (which may be a personal computer, a server, a network device, or the like) to perform all or some of steps in the methods described in embodiments of this disclosure. The storage medium includes any medium that can store program code, such as a Universal Serial Bus (USB) flash drive, a removable hard disk, a ROM, a RAM, a magnetic disk, or an optical disc.

1. A method comprising:
obtaining, from a user, description information comprising first information describing a system of linear equations and comprising a right-hand side;
performing inference on the description information using an artificial intelligence (AI) model to obtain a first initial solution corresponding to the system;
determining a target initial solution based on the first initial solution; and
iteratively solving the system based on the target initial solution to output a solving result of the system.

2. The method of claim 1, wherein the description information further comprises to-be-solved physical problem information, wherein the to-be-solved physical problem information comprises at least one of a boundary condition, mesh information, or a physical equation, and wherein the method further comprises performing a numerical simulation on the to-be-solved physical problem information to obtain the system.

3. The method of claim 1, wherein determining the target initial solution comprises:
obtaining first configuration information comprising at least one initial solution generation manner;
obtaining a plurality of initial solutions in the at least one initial solution generation manner, wherein the plurality of initial solutions comprise the first initial solution; and
selecting the target initial solution from the plurality of initial solutions.

4. The method of claim 3, wherein selecting the target initial solution from the plurality of initial-solutions comprises:
obtaining second configuration information comprising at least one heuristic policy; and
selecting the target initial solution from the initial solutions according to the at least one heuristic policy.

5. The method of claim 3, wherein selecting the target initial solution comprises:
obtaining second configuration information comprising an evaluation policy, wherein the evaluation policy comprises an evaluation indicator or comprises the evaluation indicator and a corresponding weight, and wherein the evaluation indicator comprises one or more of a solving duration, a solving precision; and, or a quantity of iterations; and
selecting the target initial solution from the plurality of initial solutions according to the evaluation policy.

6. The method of claim 1, comprising:
generating training data, wherein the training data comprises a training sample and a label corresponding to the training sample, wherein the training sample comprises the description information, and wherein the label is obtained-based on the first initial solution; and
training the AI model based on the training data to obtain an optimized AI model.

7. The method of claim 6, further comprising obtaining a performance indicator corresponding to the solving result, wherein the performance indicator comprises one or more of a solving duration, a solving precision, and, or a quantity of iterations, wherein training the AI model comprises further training the AI model based on a loss function to obtain the optimized AI model, and wherein the loss function is constructed-based on the performance indicator.

8. The method of claim 1, wherein the AI model is a general model or a first model that solves a partial differential equation (PDE), wherein the general model comprises a convolutional neural network (CNN) or a physics-informed neural network (PINN), and wherein the first model comprises a deep operator network (DeepONet).

9. An apparatus comprising:
a memory is configured to store an instruction; instructions; and
one or more processors coupled to the memory wherein when executed by the one or more processors, the instructions cause the apparatus to:
obtain, from a user, description information comprising first information describing a system of linear equations and comprising a right-hand side;
perform inference on the description information using an artificial intelligence AI model to obtain a first initial solution corresponding to the system;
determine a target initial solution based on the first initial solution; and
iteratively solve the system based on the target initial solution to output a solving result of the system of linear equations.

10. The apparatus of claim 9, wherein the description information further comprises to-be-solved physical problem information, wherein the to-be-solved physical problem information comprises at least one of a boundary condition, mesh information, or a physical equation, and wherein when executed by the one or more processors, the instructions further cause the apparatus to perform a numerical simulation on the to-be-solved physical problem information to obtain the system.

11. The apparatus of claim 9, wherein when executed by the one or more processors, the instructions further cause the apparatus to further determine the target initial solution by:
obtaining first configuration information comprising at least one initial solution generation manner;
obtaining a plurality of initial solutions in the at least one initial solution generation manner, wherein the initial solutions comprise the first initial solution; and
selecting the target initial solution from the initial solutions.

12. The apparatus of claim 11, wherein when executed by the one or more processors, the instructions further cause the apparatus to father select the target initial solution by:
obtaining second configuration information comprising at least one heuristic policy; and
selecting the target initial solution from the initial solutions according to the at least one heuristic policy.

13. The apparatus of claim 11, wherein when executed by the one or more processors, the instructions further cause the apparatus to further select the target initial solution by:
obtaining second configuration information comprising an evaluation policy, wherein the evaluation policy comprises an evaluation indicator or the evaluation indicator and a corresponding weight, and wherein the evaluation indicator comprises one or more of a solving duration, a solving precision, or a quantity of iterations; and
selecting the target initial solution from the initial solutions according to the evaluation policy.

14. The apparatus of claim 9, wherein when executed by the one or more processors, the instructions further cause the apparatus to:
generate training data, wherein the training data comprises a training sample and a label corresponding to the training sample, wherein the training sample comprises the description information, and wherein the label based on the first initial solution; and
train the AI model based on the training data to obtain an optimized AI model.

15. The apparatus of claim 14, wherein when executed by the one or more processors, the instructions further cause the apparatus to obtain a performance indicator corresponding to the solving result, wherein the performance indicator comprises one or more of a solving duration, a solving precision, or a quantity of iterations, wherein when executed by the one or more processors, the instructions further cause the apparatus to train the AI model by further training the AI model based on a loss function to obtain the optimized AI model, and wherein the loss function is based on the performance indicator.

16. The apparatus of claim 9, wherein the AI model is a general model or a first model that solves a partial differential equation (PDE), wherein the general model comprises a convolutional neural network (CNN) or a physics-informed neural network (PINN), and wherein the first model comprises a deep operator network (DeepONet).

17. A computer program product comprising computer-executable instructions that are stored on a non-transitory computer-readable storage medium and that, when executed by the one or more processors, cause an apparatus to:
obtain, from a user, description information comprising first information describing a system of linear equations and comprising a right-hand side;
perform inference on the description information using an artificial intelligence (AI) model to obtain a first initial solution corresponding to the system;
determine a target initial solution based on the first initial solution; and
iteratively solve the system of based on the target initial solution; to output a solving result of the system.

18. The computer program product of claim 17, wherein the description information further comprises to-be-solved physical problem information, wherein the to-be-solved physical problem information comprises at least one of a boundary condition, mesh information, or a physical equation, and wherein the computer-executable instructions, when executed by the one or more processors, further cause the apparatus to perform a numerical simulation on the to-be-solved physical problem information to obtain the system.

19. The computer program product of claim 17, wherein the computer-executable instructions, when executed by the one or more processors, further cause the apparatus to further determine the target initial solution by:
obtaining first configuration information comprising at least one initial solution generation manner that generates an initial solution;
obtaining a plurality of initial solutions in the at least one initial solution generation manner, wherein the initial solutions comprise the first initial solution; and
selecting the target initial solution from the initial solutions.

20. The computer program product of claim 19, wherein the computer-executable instructions, when executed by the one or more processors, further cause the apparatus to further select the target initial solution by:
obtaining second configuration information comprising at least one heuristic policy; and
selecting the target initial solution from the initial solutions according to the at least one heuristic policy.
